(19) United States
(12) Patent Application Publication
(10) Pub. No.: US 2025/0331056 A1
(43) Pub. Date: Oct. 23, 2025

(54) COMMUNICATION METHOD AND NETWORK APPARATUS

(71) Applicant: KYOCERA Corporation, Kyoto (JP)

(72) Inventor: Masato FUJISHIRO, Yokohama-shi (JP)

(73) Assignee: KYOCERA Corporation, Kyoto (JP)

(21) Appl. No.: 19/197,880

(22) Filed: May 2, 2025

Related U.S. Application Data
(63) Continuation of application No. PCT/JP2023/039402, filed on Nov. 1, 2023.

(30) Foreign Application Priority Data
Nov. 2, 2022 (JP) 2022-176581

(51) Int. Cl. H04W 76/27; H04W 4/06

(52) U.S. Cl. CPC H04W 76/27; H04W 4/06

(57) ABSTRACT

A communication method to be used in a mobile communication system that provides a multicast and broadcast service (MBS) includes transmitting, by a first network apparatus, a message for requesting continuation or discontinuation of Point-to-Multipoint (PTM) transmission to a second network apparatus that performs the PTM transmission of a multicast session.

### RELATED APPLICATIONS

The present application is a continuation based on PCT Application No. PCT/JP2023/039402, filed on Nov. 1, 2023, which claims the benefit of Japanese Patent Application No. 2022-176581 filed on Nov. 2, 2022. The content of which is incorporated by reference herein in their entirety.

### TECHNICAL FIELD

The present disclosure relates to a communication method and a network apparatus to be used in a mobile communication system.

### BACKGROUND

The 3rd Generation Partnership Project (3GPP) (trade name, the same applies hereinafter) has defined technical specifications of New Radio (NR) that is a radio access technology of the fifth generation (5G). NR has features such as high speed, large capacity, high reliability, and low latency as compared to Long Term Evolution (LTE) that is a radio access technology of the fourth generation (4G). The 3GPP has defined technical specifications of multicast and broadcast services (MBS) of 5G/NR (see, for example, Non-Patent Document 1).

### CITATION LIST

### Non-Patent Literature

Non-Patent Document 1: 3GPP Technical Specifications: TS 38.300 V17.2.0

### SUMMARY

A communication method according to a first aspect is a communication method to be used in a mobile communication system that provides a multicast and broadcast service (MBS) and includes transmitting, by a first network apparatus, a message for requesting continuation or discontinuation of Point-to-Multipoint (PTM) transmission to a second network apparatus that performs the PTM transmission of a multicast session.

A network apparatus according to a second aspect is a network apparatus to be used in a mobile communication system that provides a multicast and broadcast service (MBS) and includes a communicator configured to transmit a message for requesting continuation or discontinuation of Point-to-Multipoint (PTM) transmission to a second network apparatus that performs the PTM transmission of a multicast session.

### BRIEF DESCRIPTION OF THE DRAWINGS

FIG. 1 is a diagram illustrating a configuration of a mobile communication system according to an embodiment.

FIG. 2 is a diagram illustrating a configuration of a user equipment (UE) according to an embodiment.

FIG. 3 is a diagram illustrating a configuration of a gNB (base station) according to an embodiment.

FIG. 4 is a diagram illustrating a configuration of a protocol stack of a radio interface of a user plane handling data.

FIG. 5 is a diagram illustrating a configuration of a protocol stack of a radio interface of a control plane handling signaling (control signal).

FIGS. 6A and 6B are diagrams illustrating an overview of operation allowing the UE in an RRC inactive state to perform multicast reception.

FIG. 7 is a diagram for describing a typical cell reselection procedure.

FIG. 8 is a diagram illustrating a schematic flow of the typical cell reselection procedure.

FIG. 9 is diagram for describing a first operation pattern of the mobile communication system according to an embodiment.

FIG. 10 is a diagram illustrating an operation example of the first operation pattern of the mobile communication system according to an embodiment.

FIG. 11 is a diagram for describing a second operation pattern of the mobile communication system according to an embodiment.

FIG. 12 is a diagram illustrating an operation example of the second operation pattern of the mobile communication system according to an embodiment.

### DESCRIPTION OF EMBODIMENTS

A mobile communication system according to an embodiment is described with reference to the drawings. In the description of the drawings, the same or similar parts are denoted by the same or similar reference signs.

### (1) System Configuration

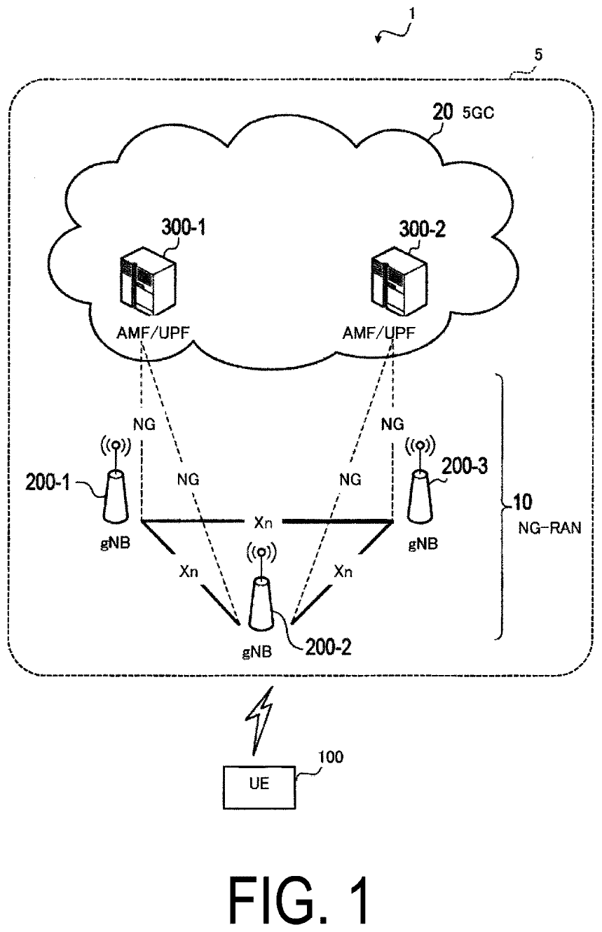

First, a configuration of a mobile communication system 1 according to an embodiment will be described. FIG. 1 is a diagram illustrating the configuration of the mobile communication system 1 according to the embodiment. The mobile communication system 1 complies with the 5th Generation System (5GS) of the 3GPP standard. The description below takes the 5GS as an example, but Long Term Evolution (LTE) system may be at least partially applied to the mobile communication system. Alternatively, a sixth generation (6G) system may be at least partially applied to the mobile communication system.

The mobile communication system 1 includes User Equipment (UE) 100, a 5G radio access network (Next Generation Radio Access Network (NG-RAN)) 10, and a 5G Core Network (5GC) 20. Hereinafter, the NG-RAN 10 may be simply referred to as a RAN 10. The 5GC 20 may be simply referred to as a core network (CN) 20. The RAN 10 and the CN 20 constitute a network of the mobile communication system 1.

The UE 100 is a mobile wireless communication apparatus. The UE 100 may be any apparatus as long as the UE 100 is used by a user. Examples of the UE 100 include a mobile phone terminal (including a smartphone) and/or a tablet terminal, a notebook PC, a communication module (including a communication card or a chipset), a sensor or an apparatus provided on a sensor, a vehicle or an apparatus provided on a vehicle (vehicle UE), and a flying object or an apparatus provided on a flying object (aerial UE).

The NG-RAN 10 includes base stations (referred to as “gNBs” in the 5G system) 200. The gNBs 200 are interconnected via an Xn interface which is an inter-base station interface. Each gNB 200 manages one or more cells. The gNB 200 performs wireless communication with the UE 100 that has established a connection to the cell of the gNB 200. The gNB 200 has a radio resource management (RRM) function, a function of routing user data (hereinafter simply referred to as “data”), a measurement control function for mobility control and scheduling, and the like. The “cell” is used as a term representing a minimum unit of a wireless communication area. The “cell” is also used as a term representing a function or a resource for performing wireless communication with the UE 100. One cell belongs to one carrier frequency (hereinafter, simply referred to as a “frequency”).

Note that the gNB can be connected to an Evolved Packet Core (EPC) corresponding to a core network of LTE. An LTE base station can also be connected to the 5GC. The LTE base station and the gNB can be connected via an inter-base station interface.

The 5GC 20 includes an Access and Mobility Management Function (AMF) and a User Plane Function (UPF) 300. The AMF performs various types of mobility control and the like for the UE 100. The AMF manages mobility of the UE 100 by communicating with the UE 100 by using Non-Access Stratum (NAS) signaling. The UPF controls data transfer. The AMF and UPF are connected to the gNB 200 via an NG interface which is an interface between a base station and the core network.

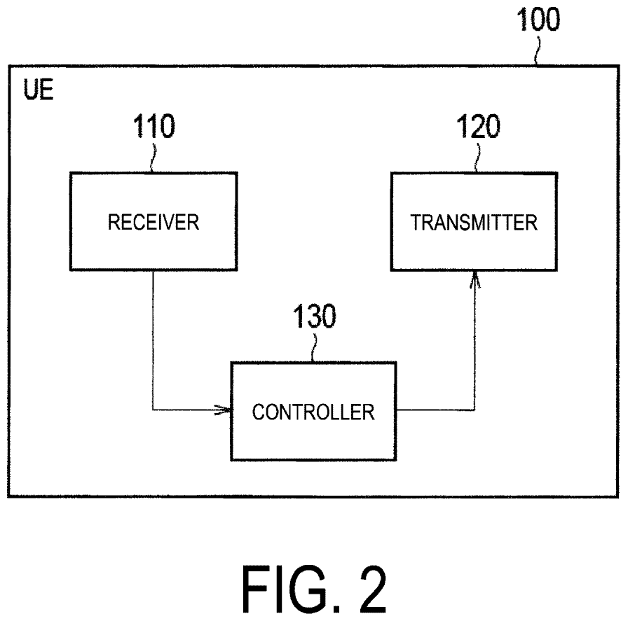

FIG. 2 is a diagram illustrating a configuration of the UE 100 (user equipment) according to an embodiment. The UE 100 includes a receiver 110, a transmitter 120, and a controller 130. The receiver 110 and the transmitter 120 constitute a wireless communicator that performs wireless communication with the gNB 200.

The receiver 110 performs various types of reception under control of the controller 130. The receiver 110 includes an antenna and a reception apparatus. The reception apparatus converts a radio signal received through the antenna into a baseband signal (a reception signal) and outputs the resulting signal to the controller 130.

The transmitter 120 performs various types of transmission under the control of the controller 130. The transmitter 120 includes an antenna and a transmission apparatus. The transmission apparatus converts a baseband signal (a transmission signal) output by the controller 130 into a radio signal and transmits the resulting signal through the antenna.

The controller 130 performs various types of control and processing in the UE 100. Such processing includes processing of respective layers to be described later. The operations of the UE 100 described above and below may also be performed under control of a controller 230. The controller 130 includes at least one processor and at least one memory. The memory stores a program to be executed by the processor and information to be used for processing by the processor. The processor may include a baseband processor and a Central Processing Unit (CPU). The baseband processor performs modulation and demodulation, coding and decoding, and the like of a baseband signal. The CPU executes the program stored in the memory to thereby perform various types of processing.

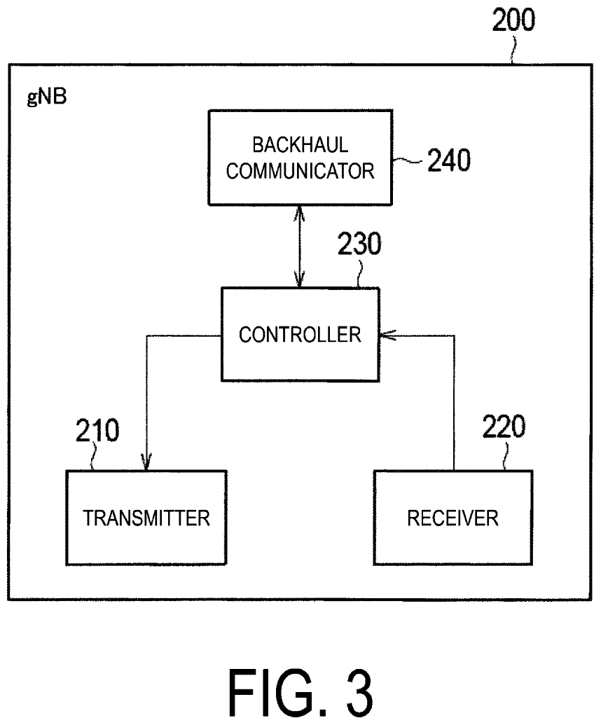

FIG. 3 is a diagram illustrating a configuration of the gNB 200 (base station) according to an embodiment. The gNB 200 includes a transmitter 210, a receiver 220, the controller 230, and a backhaul communicator 240. The transmitter 210 and the receiver 220 constitute a wireless communicator that performs wireless communication with the UE 100. The backhaul communicator 240 constitutes a network communicator that performs communication with the CN 20.

The transmitter 210 performs various types of transmission under the control of the controller 230. The transmitter 210 includes an antenna and a transmission apparatus. The transmission apparatus converts a baseband signal (a transmission signal) output by the controller 230 into a radio signal and transmits the resulting signal through the antenna.

The receiver 220 performs various types of reception under the control of the controller 230. The receiver 220 includes an antenna and a reception apparatus. The reception apparatus converts a radio signal received through the antenna into a baseband signal (a reception signal) and outputs the resulting signal to the controller 230.

The controller 230 performs various types of control and processing in the gNB 200. Such processing includes processing of respective layers to be described later. The operations of the gNB 200 described above and below may also be performed under the control of the controller 230. The controller 230 includes at least one processor and at least one memory. The memory stores a program to be executed by the processor and information to be used for processing by the processor. The processor may include a baseband processor and a CPU. The baseband processor performs modulation and demodulation, coding and decoding, and the like of a baseband signal. The CPU executes the program stored in the memory to thereby perform various types of processing.

The backhaul communicator 240 is connected to an adjacent base station via the Xn interface which is an inter-base station interface. The backhaul communicator 240 is connected to the AMF/UPF 300 via the NG interface between a base station and the core network. Note that the gNB 200 may be composed of a Central Unit (CU) and a Distributed Unit (DU) (i.e., functions are divided), and both units may be connected via an F1 interface that is a fronthaul interface.

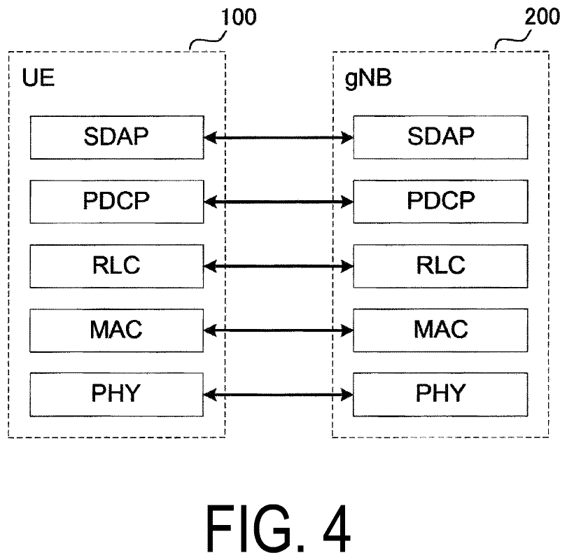

FIG. 4 is a diagram illustrating a configuration of a protocol stack of a radio interface of a user plane handling data.

A radio interface protocol of the user plane includes a PHYsical (PHY) layer, a Medium Access Control (MAC) layer, a Radio Link Control (RLC) layer, a Packet Data Convergence Protocol (PDCP) layer, and a Service Data Adaptation Protocol (SDAP) layer.

The PHY layer performs coding and decoding, modulation and demodulation, antenna mapping and demapping, and resource mapping and demapping. Data and control information are transmitted between the PHY layer of the UE 100 and the PHY layer of the gNB 200 via a physical channel. Note that the PHY layer of the UE 100 receives downlink control information (DCI) transmitted from the gNB 200 over a physical downlink control channel (PDCCH). Specifically, the UE 100 blind decodes the PDCCH using a radio network temporary identifier (RNTI) and acquires successfully decoded DCI as DCI addressed to the UE 100. A cyclic redundancy code (CRC) parity bit scrambled by the RNTI is added to the DCI transmitted from the gNB 200.

The MAC layer performs priority control of data, retransmission processing through hybrid ARQ (Hybrid Automatic Repeat reQuest (HARQ)), a random access procedure, and the like. Data and control information are transmitted between the MAC layer of the UE 100 and the MAC layer of the gNB 200 via a transport channel. The MAC layer of the gNB 200 includes a scheduler. The scheduler decides transport formats (transport block sizes, Modulation and Coding Schemes (MCSs)) in the uplink and the downlink and resource blocks to be allocated to the UE 100.

The RLC layer transmits data to the RLC layer on the reception side by using functions of the MAC layer and the PHY layer. Data and control information are transmitted between the RLC layer of the UE 100 and the RLC layer of the gNB 200 via a logical channel.

The PDCP layer performs header compression and decompression, encryption and decryption, and the like.

The SDAP layer performs mapping between an IP flow as the unit of Quality of Service (QOS) control performed by a core network and a radio bearer as the unit of QoS control performed by an Access Stratum (AS). Note that, when the RAN is connected to the EPC, the SDAP layer need not be provided.

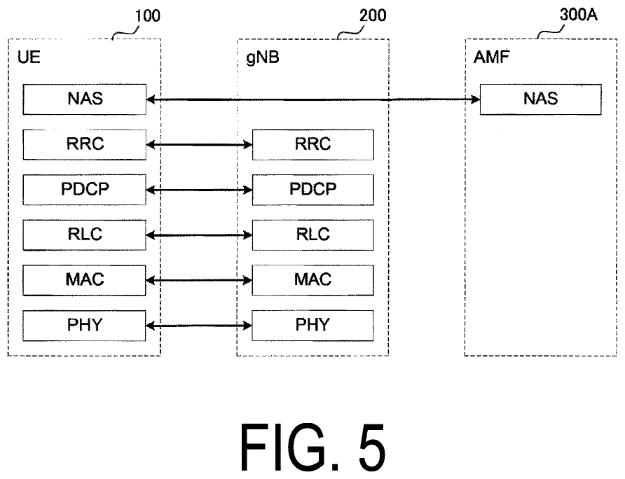

FIG. 5 is a diagram illustrating a configuration of a protocol stack of a radio interface of a control plane handling signaling (a control signal).

The protocol stack of the radio interface of the control plane includes a Radio Resource Control (RRC) layer instead of the SDAP layer illustrated in FIG. 4 and a Non-Access Stratum (NAS) layer.

RRC signaling for various configurations is transmitted between the RRC layer of the UE 100 and the RRC layer of the gNB 200. The RRC layer controls a logical channel, a transport channel, and a physical channel according to establishment, re-establishment, and release of a radio bearer. When a connection is present between the RRC layer of the UE 100 and the RRC layer of the gNB 200 (RRC connection), the UE 100 is in an RRC connected state. When no connection is present between the RRC layer of the UE 100 and the RRC layer of the gNB 200 (RRC connection), the UE 100 is in an RRC idle state. When the connection between the RRC layer of the UE 100 and the RRC layer of the gNB 200 is suspended, the UE 100 is in an RRC inactive state.

The NAS layer (also referred to simply as an “NAS”) that is positioned upper than the RRC layer performs session management, mobility management, and the like. NAS signaling is transmitted between the NAS layer of the UE 100 and the NAS layer of an AMF 300A. Note that the UE 100 includes an application layer other than the protocol of the radio interface. Each layer lower than the NAS layer is referred to as an AS layer (also referred to simply as an “AS”).

### (2) MBS

The mobile communication system 1 can perform delivery with high resource efficiency by using the multicast and broadcast service (MBS).

In a multicast communication service (also referred to as “MBS multicast”), the same service and the same specific content data are simultaneously provided to a specific UE set. That is, not every UE 100 in a multicast service area is allowed to receive data. The multicast communication services are delivered to the UE 100 using a multicast session, which is a type of an MBS session. The UE 100 can receive the multicast communication services in the RRC connected state using mechanisms such as Point-to-Point (PTP) and/or Point-to-Multipoint (PTM) delivery. The UE 100 may receive the multicast communication services in the RRC inactive (or RRC idle) state. Such a delivery mode is also referred to as “delivery mode 1”.

In broadcast communication services (also referred to as “MBS broadcast”), the same service and the same specific content data are provided simultaneously to every UE 100 within a geographic area. That is, every UE 100 in a broadcast service area is allowed to receive the data. The broadcast communication services are delivered to the UE 100 using a broadcast session, which is a type of the MBS session. The UE 100 can receive the broadcast communication services in any state of the RRC idle state, the RRC inactive state, and the RRC connected state. Such a delivery mode is also referred to as “delivery mode 2”.

Main logical channels used for MBS delivery are a multicast traffic channel (MTCH), a dedicated traffic channel (DTCH), and a multicast control channel (MCCH). The MTCH is a PTM downlink channel for transmitting MBS data of either a multicast session or a broadcast session from the network 10 to the UE 100. The DTCH is a PTP channel for transmitting MBS data of a multicast session from the network 10 to the UE 100. The MCCH is a PTM downlink channel for transmitting MBS broadcast control information associated with one or more MTCHs from the network 10 to the UE 100.

Regarding a configuration of the MBS broadcast, the UE 100 in the RRC idle state, the RRC inactive state, or the RRC connected state receives a PTM configuration for a broadcast session (e.g., parameters required for MTCH reception) via the MCCH. Parameters required for reception of the MCCH (MCCH configuration) are provided through system information. In particular, system information block type 20 (SIB 20) includes the MCCH configuration. Note that SIB type 21 (SIB 21) includes information related to service continuity of MBS broadcast reception. The MCCH provides a list of all broadcast services including an ongoing session transmitted on the MTCH, and information related to the broadcast session includes an MBS session identification information (e.g., Temporary Mobile Group Identity (TMGI)), related MTCH scheduling information, and information on a neighboring cell providing a specific service on the MTCH.

On the other hand, regarding the MBS multicast, the current technical specifications of the 3GPP enable the UE 100 to receive data of multicast sessions only in RRC connected state. When the UE 100 participating in the multicast sessions is in the RRC connected state and the multicast sessions are activated, the gNB 200 transmits an RRC Reconfiguration message including a PTM configuration on the multicast sessions to the UE 100. Such PTM configuration is also referred to as a multicast radio bearer (MRB) configuration, an MTCH configuration, or a multicast configuration. The MRB configuration (MRB-ToAddMod) includes other parameters such as the MBS session identification information (mbs-SessionId), an MRB identifier (mrb-Identity), and a PDCP configuration (pdcp-Config), for an MRB (multicast MRB) to be configured to the UE 100.

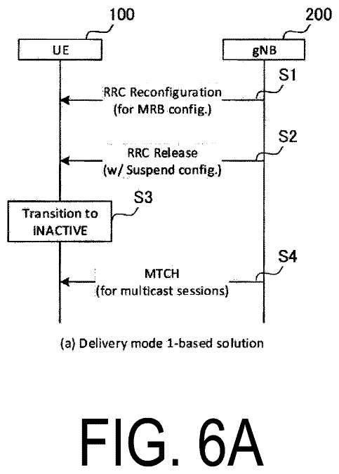

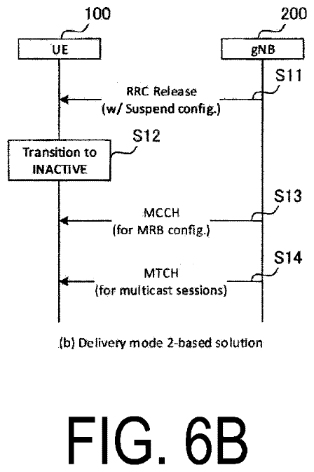

In the following embodiment, operation of enabling the UE 100 in the RRC inactive state to perform multicast reception will be mainly described. FIGS. 6A and 6B illustrate an overview of the operation.

As a solution for the UE 100 in the RRC inactive state to perform multicast reception, a solution based on the delivery mode 1 illustrated in FIG. 6A and a solution based on the delivery mode 2 illustrated in FIG. 6B are considered.

In the solution based on the delivery mode 1 illustrated in FIG. 6A, in step S1, the gNB 200 transmits an RRC Reconfiguration message including the MBS configuration (multicast configuration) related to multicast sessions to the UE 100 in the RRC connected state. The UE 100 receives multicast data on the MTCH via the multicast sessions (multicast MRB) based on the multicast configuration received in the RRC Reconfiguration message.

In step S2, the gNB 200 transmits an RRC release (Release) message for causing the UE 100 to transition to the RRC inactive state from the UE 100 in the RRC connected state. The RRC Release message includes a configuration (Suspend Config.) for the RRC inactive state.

In step S3, the UE 100 transitions from the RRC connected state to the RRC inactive (INACTIVE) state in response to reception of the RRC Release message in step S2.

In step S4, the UE 100 in the RRC inactive state continues using the multicast configuration of step S1 to receive the multicast data on the MTCH through the multicast sessions.

This enables the UE 100 in the RRC inactive state to perform multicast reception. Note that, although an example in which the multicast configuration is performed using an RRC Reconfiguration message has been described, the multicast configuration may be performed using an RRC Release message.

Both the RRC Reconfiguration message and the RRC Release message are RRC messages transmitted per UE on the dedicated control channel (DCCH) and are hereinafter also referred to as dedicated RRC messages.

On the other hand, in the solution based on the delivery mode 2 illustrated in FIG. 6B, in step S11, the gNB 200 transmits an RRC Release message for causing the UE 100 to transition to the RRC inactive state from the UE 100 in the RRC connected state. The RRC Release message includes a configuration (Suspend Config.) for the RRC inactive state.

In step S12, the UE 100 transitions to the RRC inactive (INACTIVE) state in response to reception of the RRC Release message in step S11.

In step S13, the gNB 200 transmits the MCCH including the MBS configuration (multicast configuration) for the multicast sessions. The UE 100 receives the MCCH. Note that the UE 100 receives the SIB 20 prior to the reception of the MCCH and receives the MCCH based on the SIB 20. Note that the MCCH transmission (and reception) may be performed before step S11 or may be performed simultaneously with step S11.

In step S14, the UE 100 in the RRC inactive state receives the multicast data on the MTCH via the multicast sessions based on the multicast configuration received on the MCCH in step S13. This enables the UE 100 in the RRC inactive state to perform multicast reception.

### (3) Cell Reselection

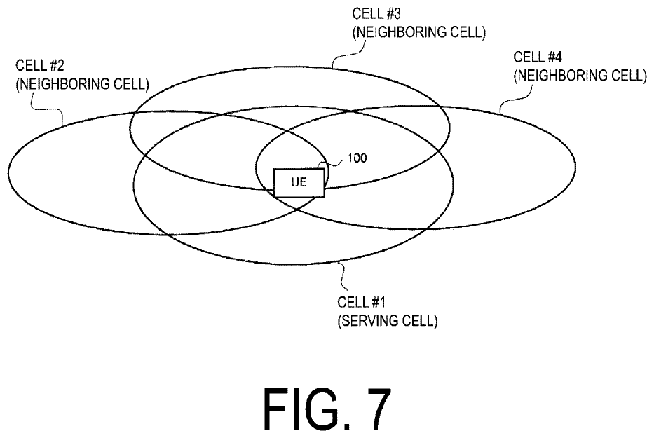

FIG. 7 is a diagram for describing a typical cell reselection procedure. The UE 100 in the RRC idle state or the RRC inactive state performs the cell reselection procedure to migrate from a current serving cell (cell #1) to a neighboring cell (any one of cells #2 to #4) as the UE 100 migrates. More specifically, the UE 100 specifies a neighboring cell on which the UE needs to camp by the cell reselection procedure and reselects the specified neighboring cell. Frequencies (carrier frequencies) that are the same between the current serving cell and the neighboring cell will be referred to as intra-frequencies, and frequencies (carrier frequencies) that are different between the current serving cell and the neighboring cell will be referred to as inter-frequencies. The current serving cell and the neighboring cell may be managed by the same gNB 200. The current serving cell and the neighboring cell may be managed by the gNBs 200 different from each other.

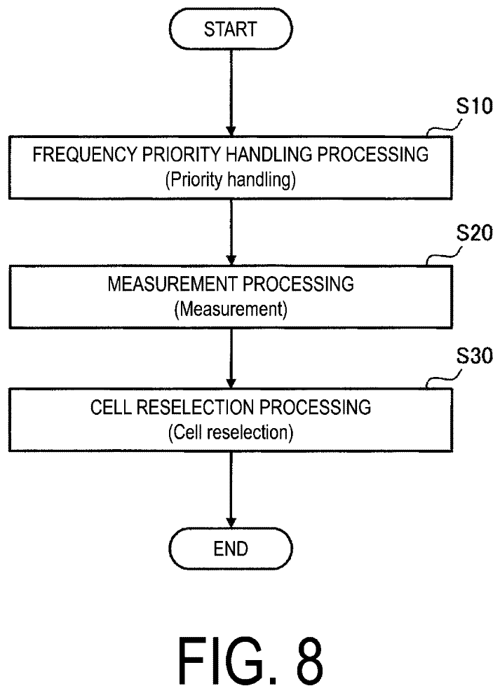

FIG. 8 is a diagram illustrating a schematic flow of the typical cell reselection procedure.

In step S10, the UE 100 performs frequency priority handling processing based on a priority (also referred to as an “absolute priority”, a “cell reselection priority”, or a “dedicated priority”) of each frequency designated by the gNB 200 with, for example, a system information block (SIB) or an RRC release message. More specifically, the UE 100 manages the frequency priority designated by the gNB 200 per frequency.

In step S20, the UE 100 performs measurement processing of measuring radio qualities of the serving cell and each of the neighboring cells. The UE 100 measures reception powers and reception qualities of reference signals transmitted by the serving cell and each of the neighboring cells, more specifically, a Cell Defining-Synchronization Signal and PBCH block (CD-SSB). For example, the UE 100 measures the radio quality of the frequencies having higher priorities than a priority of the frequency of the current serving cell at all times, and, as for frequencies having priorities equal to or lower than the priority of the frequency of the current serving cell, measures the radio quality of the frequencies having priorities equal to or lower than the priority of the frequency of the current serving cell when the radio quality of the current serving cell goes below a predetermined quality.

In step S30, the UE 100 performs the cell reselection processing of reselecting a cell on which the UE 100 camps based on the measurement result in step S20. For example, when the priority of a frequency of a neighboring cell is higher than the priority of the current serving cell and the neighboring cell satisfies a predetermined quality standard (i.e., minimal required quality standard) for a predetermined period of time, the UE 100 may perform cell reselection for the neighboring cell. When the priorities of the frequencies of the neighboring cells are the same as the priority of the current serving cell, the UE 100 may rank the radio qualities of the neighboring cells and perform cell reselection for the neighboring cells ranked higher than the ranking of the current serving cell for a predetermined period of time. When the priorities of the frequencies of the neighboring cells are lower than the priority of the current serving cell, the radio quality of the current serving cell is lower than a certain threshold, and the radio qualities of the neighboring cells are continuously higher than another threshold for the predetermined period of time, the UE 100 may perform cell reselection for the neighboring cell.

The UE 100, in the RRC idle state or the RRC inactive state that supports the MBS, performs the cell reselection described above adding the following changes. More specifically, when the UE 100 that is receiving or is interested in receiving MBS broadcast services via Point-to-Multipoint (PTM) can receive these MBS broadcast services only by camping on a frequency at which these MBS broadcast services are performed, the UE 100 is permitted to make the frequency the highest priority (higher than the priorities configured by other networks).

On the other hand, when the MBS broadcast services that the UE 100 is interested in is no longer available (after an end of a session) or when the UE 100 is no longer interested in receiving the broadcast services, the UE 100 no longer prioritizes the frequency. The UE 100 that is receiving or is interested in receiving the MBS broadcast services via PTM is permitted to make frequencies at which these MBS broadcast services cannot be received the lowest priority (lower than the priorities configured by the other networks).

### (4) Operation According to Embodiment

Each operation pattern according to an embodiment will be described. Hereinafter, a scenario in which the UE 100 in the RRC inactive state performs multicast reception is assumed. The above-described solution based on the delivery mode 1 may be applied. The above-described solution based on the delivery mode 2 may be applied. Note that a scenario in which the UE 100 in the RRC idle state performs multicast reception may be assumed. That is, the RRC inactive state in the description of the embodiment below may be read as the RRC idle state.

### (4.1) First Operation Pattern

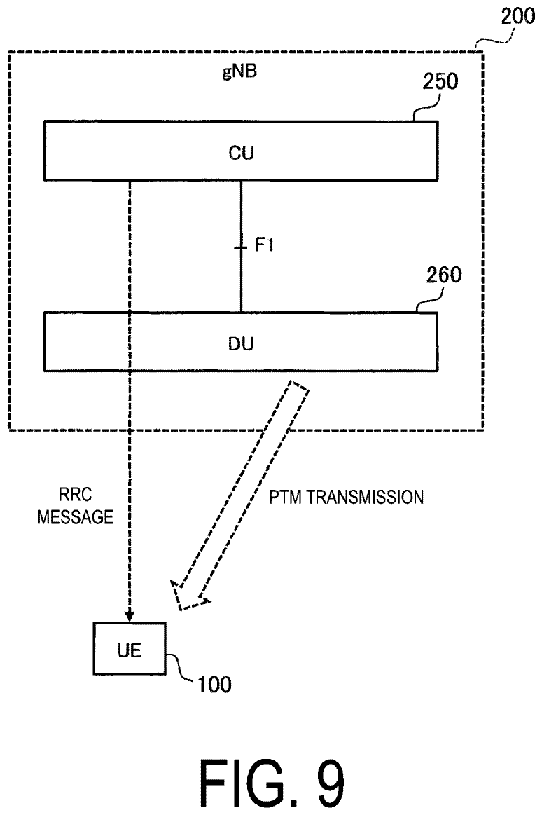

FIG. 9 is a diagram for describing a first operation pattern of the mobile communication system 1 according to an embodiment.

In the example illustrated in the diagram, the gNB 200 is functionally divided into a Central Unit (CU) 250 and a Distributed Unit (DU) 260. Although an example is illustrated in which the number of DUs 260 is one, the number of DUs 260 may be two or more. In the first operation pattern, the CU 250 corresponds to the first network apparatus, and the DU 260 corresponds to the second network apparatus.

The CU 250 is a logical node including the RRC, SDAP, and PDCP layers (protocols) of the gNB 200. The CU 250 controls an operation of the DU. The CU 250 is connected to the DU 260 via the F1 interface, which is a fronthaul interface. The CU is connected to an adjacent base station via the Xn interface, which is an inter-base station interface. The DU 260 is a logical node including the RLC, MAC and PHY layers (protocols) of the gNB 200. The DUs 260 form one or more cells.

Under such premise, the DU 260 determines whether to perform the PTP (Point-to-Point) transmission or the PTM (Point-to-Multipoint) transmission of the multicast sessions (multicast date) to the UE 100. For example, the DU 260 performs scheduling on a per UE basis using a C-RNTI in the PTP transmission and performs scheduling on a per UE group basis using a G-RNTI in the PTM transmission. When the UE 100 in the RRC inactive state performs multicast reception, the PTM transmission can be applied for the UE 100, but the PTP transmission cannot be applied for the UE 100.

On the other hand, the CU 250 transmits one or more RRC messages to the UE 100, thereby transmitting the PTM configuration to the UE 100 or causing the UE 100 to transition to the RRC inactive state. The RRC messages are transmitted between the UE 100 and the CU 250 on the RRC layer. The DU 260 therefore cannot recognize the content of the RRC message.

Under such premise, when the CU 250 causes the UE 100 to transition to the RRC inactive state, the DU 260 discontinuing the PTM transmission causes a problem that the UE 100 cannot continue the MBS reception. The DU 260 therefore is desirably allowed to continue the PTM transmission to the UE 100 in the RRC inactive state. When the DU 260 intends to discontinue the PTM transmission, the CU 250 is desirably capable of causing the UE 100 to transition to the RRC connected state by, for example, paging.

In the operation pattern above, the CU 250 transmits a message for requesting continuation or discontinuation of the PTM transmission to the DU 260 that performs the PTM transmission of the multicast sessions. This allows the CU 250 to cause the DU 260 to continue or discontinue the PTM transmission.

The message includes the session identification information of the multicast sessions. The session identification information may be the TMGI, an MRB ID, and/or an MBS QOS Flow ID. This allows the DU 260 to identify the multicast sessions for which to continue or discontinue the PTM transmission. For example, the CU 250 notifies the DU 260 of the TMGI that requests continuation of the PTM transmission or permits discontinuation of the PTM transmission. The DU 260 may notify the CU 250 of the TMGI of which PTM transmission is intended to be discontinued.

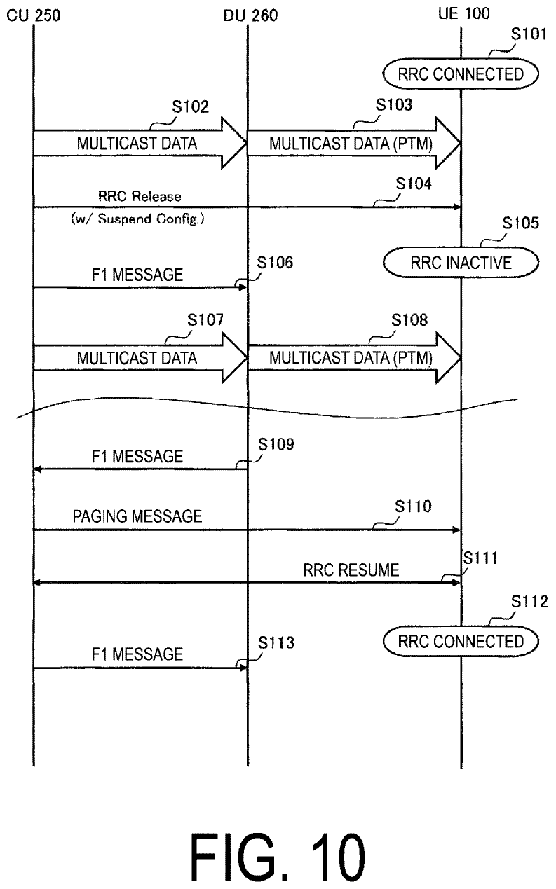

FIG. 10 is a diagram illustrating an operation example of the first operation pattern of the mobile communication system 1 according to an embodiment.

In step S101, the UE 100 is in the RRC connected state. The UE 100 participates in multicast sessions (here, multicast session #1). The UE 100 may receive an RRC message including a PTM configuration for receiving the multicast session #1 from the CU 250.

In step S102, the CU 250 transmits multicast data of the multicast session #1 to the DU 260. The DU 260 receives the multicast data.

In step S103, the DU 260 transmits the multicast data from the CU 250 to the UE 100 by the PTM transmission. The UE 100 receives the multicast data.

In step S104, the CU 250 transmits an RRC Release message including Suspend Config. to the UE 100. The UE 100 receives the RRC Release message.

In step S105, the UE 100 transitions to the RRC inactive state from the RRC connected state in response to reception of the RRC Release message.

In step S106, the CU 250 transmits a message including session identification information of the multicast session #1 received by the UE 100 in the RRC inactive state to the DU 260 over the F1 interface. The DU 260 receives the message. The session identification information includes a TMGI, a source IP address, an MRB ID, and/or an MBS QOS Flow ID. The message may be a UE Context Setup Request message, a UE Context Modification Request message, a MULTICAST CONTEXT SETUP REQUEST message, a MULTICAST CONTEXT MODIFICATION REQUEST message, or a newly defined message. The message may include information requesting the DU 260 of the PTM transmission. The information may be a notification indicating that discontinuation of the PTM transmission is not permitted. The message may be information indicating that the (at least one) UE 100 in the RRC inactive state receives (or is receiving or is likely to receive) the multicast sessions indicated by the session identification information. Alternatively, the message may be information indicating that there is no UE 100 to receive in the RRC inactive state the multicast sessions indicated by the session identification information.

The DU 260 continues the operation of transmitting the multicast data from the CU 250 to the UE 100 by the PTM transmission in response to reception of the message (step S107, step S108).

In step S109, the DU 260 may transmit a message, including the session identification information of the multicast session #1 of which PTM transmission is intended to be discontinued, to the CU 250 over the F1 interface. The message may be a UE CONTEXT MODIFICATION REQUIRED message, a NOTIFY message, a MULTICAST CONTEXT RELEASE REQUEST message, a MULTICAST DISTRIBUTION RELEASE COMMAND message, or a new message. The CU 250 receives the message. The message may include information requesting the discontinuation of the PTM transmission. The information may be a request for causing the UE 100 receiving the multicast session #1 to transition to the RRC connected state, transmission of paging, or a request for calling the UE 100.

In step S110, the CU 250 transmits a paging message including, for example, the session identification information of the multicast session #1 to the UE 100.

In step S111, the UE 100, together with the CU 250, executes processing of RRC resume and transitions from the RRC inactive state to the RRC connected state (step S112).

In step S113, the CU 250 may transmit a message, including the session identification information of the multicast session #1 of which PTM transmission can be discontinued, to the DU 260 over the F1 interface. The message may be a UE Context Setup Request message, a UE Context Modification Request message, a MULTICAST CONTEXT RELEASE REQUEST message, a MULTICAST DISTRIBUTION SETUP REQUEST message, a MULTICAST DISTRIBUTION RELEASE COMMAND message, or a newly defined message. The DU 260 that has received the message performs processing such as discontinuation of the PTM transmission or switching to the PTP transmission for the multicast session #1 based on the message.

### (4.2) Second Operation Pattern

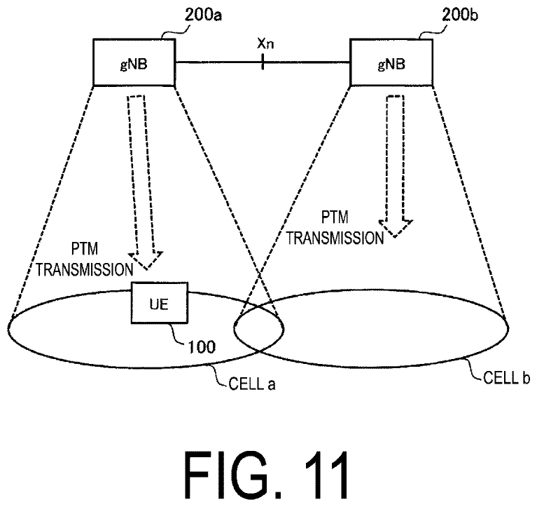

FIG. 11 is a diagram for describing a second operation pattern of the mobile communication system 1 according to an embodiment.

In this operation pattern, the multiple gNBs 200 (gNB 200a and gNB 200b in the illustrated example) transmit the same multicast sessions (here, multicast session #1) by the PTM transmission using the common PTM configuration. In the operation pattern above, the gNB 200a corresponds to the first network apparatus, and the gNB 200b corresponds to the second network apparatus.

That is, the PTM configuration is valid in an area including a cell a of the gNB 200a and a cell b of the gNB 200b. After the gNB 200a causes the UE 100 to transition to the RRC inactive state, the UE 100 performs multicast reception (PTM reception) in the RRC inactive state in the cell a of the gNB 200a. Note that the gNB 200a and the gNB 200b are connected via the Xn interface which is an inter-base station interface.

Under such premise, the UE 100 in the RRC inactive state may move from the cell a of the gNB 200a to the cell b of the gNB 200b (i.e., neighboring cell of cell a). Here, even when the gNB 200a continues the PTM transmission, there is a problem that the UE 100 cannot continue the multicast reception when the gNB 200b discontinues the PTM transmission.

In the operation pattern above, the gNB 200a transmits a message for requesting continuation or discontinuation of the PTM transmission to the gNB 200b that performs the PTM transmission of the multicast sessions. This allows the gNB 200a to cause the gNB 200b to continue or discontinue the PTM transmission.

The message includes the session identification information of the multicast sessions. The session identification information may be the TMGI, the MRB ID, and/or the MBS QOS Flow ID. This allows the gNB 200b to identify the multicast sessions of which PTM transmission is to be continued or discontinued. For example, the gNB 200a notifies the gNB 200b of the TMGI that requests continuation of the PTM transmission or permits discontinuation of the PTM transmission. The message may be information indicating that the (at least one) UE 100 in the RRC inactive state receives (or is receiving or is likely to receive) the multicast sessions indicated by the session identification information. Alternatively, the message may be information indicating that there is no UE 100 to receive the multicast sessions indicated by the session identification information in the RRC inactive state. The gNB 200b may notify the gNB 200a of the TMGI of which PTM transmission is intended to be discontinued.

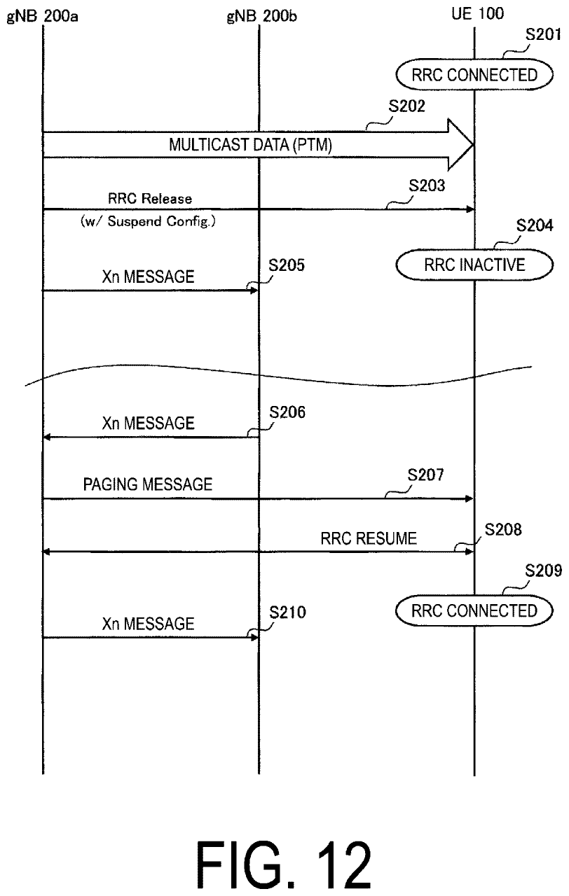

FIG. 12 is a diagram illustrating an operation example of the second operation pattern of the mobile communication system 1 according to an embodiment.

In step S201, the UE 100 is in the RRC connected state. The UE 100 participates in multicast sessions (here, multicast session #1). The UE 100 may receive an RRC message, including a PTM configuration for receiving the multicast session #1, from the gNB 200a.

In step S202, the gNB 200a transmits multicast data of the multicast session #1 to the UE 100 by the PTM transmission. The UE 100 receives the multicast data.

In step S203, the gNB 200a transmits an RRC Release message including Suspend Config. to the UE 100. The UE 100 receives the RRC Release message.

In step S204, the UE 100 transitions from the RRC connected state to the RRC inactive state in response to reception of the RRC Release message.

In step S205, the gNB 200a transmits a message to the gNB 200b over the Xn interface, the message including the session identification information of the multicast session #1 that the UE 100 receives in the RRC inactive state. The gNB 200b receives the message. The session identification information includes the TMGI and/or the source IP address. The message may be a newly defined message (e.g., a Multicast session activation request message). The message may include information requesting the gNB 200b of the PTM transmission. The information may be a notification indicating that discontinuation of the PTM transmission is not permitted.

Note that the gNB 200a may transmit a message to each of other gNBs constituting a predetermined area in which the PTM configuration (common PTM configuration) is valid for the multicast session #1. The predetermined area may be a registration area (RA), a tracking area (TA), or a RAN notification area (RNA).

The gNB 200b continues the operation of transmitting the multicast data of the multicast session #1 by the PTM transmission in response to reception of the message.

In step S206, the gNB 200b may transmit a message, including the session identification information of the multicast session #1 of which PTM transmission is intended to be discontinued, to the gNB 200a over the Xn interface. The message may be a newly defined message, for example, a Multicast session stop request message, a Paging request message, or a Multicast group paging request message. The gNB 200a receives the message. The message may include information requesting the discontinuation of the PTM transmission. The information may be a request to cause the UE 100 receiving the multicast session #1 to transition to the RRC connected state. The gNB 200b may trigger paging (RAN paging). For example, the gNB 200b may call the UE 100 by transmitting a paging message including the session identification information of the multicast session #1.

In step S207, the gNB 200a transmits a paging message including the session identification information of the multicast session #1 to the UE 100.

In step S208, the UE 100, together with the gNB 200a, executes processing of RRC resume and transitions from the RRC inactive state to the RRC connected state (step S209).

In step S210, the gNB 200a may transmit a message, including the session identification information of the multicast session #1 of which PTM transmission can be discontinued, to the gNB 200b over the Xn interface. The gNB 200b that has received the message performs, for the multicast session #1, processing such as discontinuation of the PTM transmission or switching to the PTP transmission based on the message.

In the operation example above, an example in which a message is transmitted and received over the Xn interface has been described. However, when there is no Xn interface (Xn connection) between the gNB 200a and the gNB 200b, a message may be transmitted and received via the AMF 300A. In this case, the gNB 200a may transmit a message, including the TMGI of the multicast session #1 in which multicast reception is performed in the RRC inactive state, to the AMF 300A over the NG interface. Here, the gNB 200a may notify the AMF 300A of information of the predetermined area. The AMF 300A may transmit the information to each of other gNBs 200 in the predetermined area over the NG interface.

The gNB 200a may be notified by the gNB 200b in periphery, of an identifier of multicast sessions provided by the gNB 200b and information on whether the multicast sessions are provided by the PTM transmission. The notification is transmitted by an Xn message (for example, Multicast session information or Multicast PTM delivery information). Alternatively, the gNB 200a may be notified by the AMF 300 of an identifier of multicast sessions provided by the gNB 200b in periphery and information on whether the multicast sessions are provided by the PTM transmission. The notification is transmitted by an NG message (for example, Multicast session information or Multicast PTM delivery information). The gNB 200a may configure the valid area of the PTM configuration to the UE 100 by using the information.

### (5) Other Embodiments

The operation flows described above can be separately and independently implemented and also be implemented in combination of two or more of the operation flows. For example, some steps of one operation flow may be added to another operation flow or some steps of one operation flow may be replaced with some steps of another operation flow. In each flow, all steps may not be necessarily performed, and only some of the steps may be performed.

Although an example in which the base station is an NR base station (gNB) has been described in the embodiments and examples described above, the base station may be an LTE base station (eNB) or a 6G base station. The base station may be a relay node such as an Integrated Access and Backhaul (IAB) node. The base station may be a DU of the IAB node. The UE 100 may be a mobile termination (MT) of the IAB node.

A program causing a computer to execute each of the processing performed by the UE 100 or the gNB 200 may be provided. The program may be recorded in a computer readable medium. Use of the computer readable medium enables the program to be installed on a computer. Here, the computer readable medium on which the program is recorded may be a non-transitory recording medium. The non-transitory recording medium is not particularly limited and may be, for example, a recording medium such as a CD-ROM or a DVD-ROM. Circuits for executing processing performed by the UE 100 or the gNB 200 may be integrated, and at least a part of the UE 100 or the gNB 200 may be implemented as a semiconductor integrated circuit (chipset, System on a chip (SoC)).

The term “network node” mainly means a base station but may also mean a core network apparatus or a part (CU, DU, or RU) of the base station.

The phrases “based on” and “depending on/in response to” used in the present disclosure do not mean “based only on” and “only depending on/in response to” unless specifically stated otherwise. The phrase “based on” means both “based only on” and “based at least in part on”. The phrase “depending on” means both “only depending on” and “at least partially depending on”. The terms “include”, “comprise” and variations thereof do not mean “include only items stated” but instead mean “may include only items stated” or “may include not only the items stated but also other items”. The term “or” used in the present disclosure is not intended to be “exclusive or”. Any references to elements using designations such as “first” and “second” as used in the present disclosure do not generally limit the quantity or order of those elements. These designations may be used herein as a convenient method of distinguishing between two or more elements. Thus, a reference to first and second elements does not mean that only two elements may be employed there or that the first element needs to precede the second element in some manner. For example, when the English articles such as “a”, “an”, and “the” are added in the present disclosure through translation, these articles include the plural unless clearly indicated otherwise in context.

Embodiments have been described above in detail with reference to the drawings, but specific configurations are not limited to those described above, and various design variation can be made without departing from the gist of the present disclosure.

### (6) SUPPLEMENTARY NOTES

Features relating to the embodiments described above are described below as supplements.

### Supplementary Note 1

A communication method to be used in a mobile communication system that provides a multicast and broadcast service (MBS), the communication method including transmitting, by a first network apparatus, a message for requesting continuation or discontinuation of Point-to-Multipoint (PTM) transmission to a second network apparatus that performs the PTM transmission of a multicast session.

### Supplementary Note 2

The communication method according to supplementary note 1, wherein the message includes session identification information of the multicast session.

### Supplementary Note 3

The communication method according to supplementary note 1 or 2, further including causing, by the first network apparatus, a user equipment to transition from a radio resource control (RRC) connected state to an RRC inactive state, wherein the transmitting a message includes transmitting the message for requesting continuation of the PTM transmission to the second network apparatus when the user equipment is in the RRC inactive state and receives the multicast session.

### Supplementary Note 4

The communication method according to any one of supplementary notes 1 to 3, wherein the first network apparatus is a central unit included in a base station, and the second network apparatus is a distributed unit included in the base station.

### Supplementary Note 5

The communication method according to any one of supplementary notes 1 to 3, wherein the first network apparatus is a first base station configuring a predetermined area, and the second network apparatus is a second base station configuring the predetermined area.

### Supplementary Note 6

A network apparatus to be used in a mobile communication system that provides a multicast and broadcast service (MBS), the network apparatus including a communicator configured to transmit a message for requesting continuation or discontinuation of Point-to-Multipoint (PTM) transmission to a second network apparatus that performs the PTM transmission of a multicast session.

### REFERENCE SIGNS

1: Mobile communication system
5: Network
10: RAN
20: CN
100: User equipment (UE)
110: Receiver
120: Transmitter
130: Controller
200: gNB (Base station)
210: Transmitter
220: Receiver
230: Controller
240: Backhaul communicator

1. A communication method to be used in a mobile communication system that provides a multicast and broadcast service (MBS), the communication method comprising
transmitting, by a first network apparatus, a message for requesting continuation or discontinuation of Point-to-Multipoint (PTM) transmission to a second network apparatus that performs the PTM transmission of a multicast session.

2. The communication method according to claim 1, wherein the message includes session identification information of the multicast session.

3. The communication method according to claim 1, further comprising
causing, by the first network apparatus, a user equipment to transition from a radio resource control (RRC) connected state to an RRC inactive state, wherein
the transmitting a message comprises transmitting the message for requesting continuation of the PTM transmission to the second network apparatus when the user equipment is in the RRC inactive state and receives the multicast session.

4. The communication method according to claim 1,
wherein the first network apparatus is a central unit included in a base station, and
the second network apparatus is a distributed unit included in the base station.

5. The communication method according to claim 1,
wherein the first network apparatus is a first base station configuring a predetermined area, and
the second network apparatus is a second base station configuring the predetermined area.

6. A network apparatus to be used in a mobile communication system that provides a multicast and broadcast service (MBS), the network apparatus comprising
a communicator configured to transmit a message for requesting continuation or discontinuation of Point-to-Multipoint (PTM) transmission to a second network apparatus that performs the PTM transmission of a multicast session.
